(19) United States
(12) Patent Application Publication
(10) Pub. No.: US 2020/0069088 A1
(43) Pub. Date: Mar. 5, 2020

(54) METHOD FOR BLOCKING NOISE IN NOISE CANCELING PILLOW AND NOISE CANCELING PILLOW

(71) Applicant: Yongkuk KIM, Gyeonggi-do (KR)

(72) Inventor: Yongkuk KIM, Gyeonggi-do (KR)

(21) Appl. No.: 16/491,692

(22) PCT Filed: Mar. 6, 2018
(86) PCT No.: PCT/KR2018/002617

§ 371 Date: Sep. 6, 2019

(30) Foreign Application Priority Data
Mar. 7, 2017 (KR) 10-2017-0028764

(51) Int. Cl. A47G 9/10; G10K 11/178

(52) U.S. Cl. CPC A47G 9/1045; A47G 2200/143; G10K 11/17821; G10K 11/17857

(57) ABSTRACT

A method for blocking noise in a noise canceling pillow, and a noise canceling pillow. The method for blocking noise in a noise canceling pillow can include the following steps in which a forward microphone receives a noise signal; a noise canceling speaker generates a noise canceling signal determined on the basis of the noise signal; a feedback microphone receives a noise canceled signal generated by the destructive interference between the noise signal and the noise canceling signal; and a processor determines whether to change the noise canceling signal on the basis of the noise canceled signal.

### TECHNICAL FIELD

The present invention relates to a method of blocking canceling noise in a noise canceling pillow and a noise canceling pillow. More specifically, the present invention relates to a method of canceling noise which provides a more comfortable bedtime to a user by blocking unnecessary noise around the user on the basis of active noise cancelling (ANC) and a noise canceling pillow which performs the same.

### BACKGROUND ART

The use of earphones or headphones is increasing and more people are listening to music in various environments as mobile devices are evolving. In a case in which a user listens to music in a high noise environment such as an airplane, a bus, and a street, it is difficult to stably listen to the music due to loud background noise. Accordingly, noise canceling headphones using active noise cancelling (ANC) are being developed and distributed in order to improve listening by removing the background noise.

An ANC system uses a superposition principle which is a characteristic of a sound. Noise control signals (or noise canceling signals) having phases opposite to phases of noise may be generated, and external noise introduced into ear pads of the headphones may be canceled by the noise control signals. ANC systems may be mainly classified as feed forward systems and feedback systems according to a structure thereof.

A feed forward system can generate control signals such that noise signals are minimized at positions of error microphones in headphones on the basis of noise signals measured by reference microphones positioned outside the headphones and can reduce noise in a wideband without distorting music signals. However, a feedback system has a structure configured to control noise using reference signals mixed by error microphones in headphones and has a high noise removal rate in a low frequency band.

ANC systems can be used for various products in addition to the headphones. Many people complain of insomnia because of not sleeping properly due to a snore of people sleeping together or ambient noise. The ANC systems may also be used in sleeping environments. In the case in which the ANC systems are used in the sleeping environments, a noise process should be performed on the basis of ANC technology in open environments, which are not shielded, unlike the headphones. Accordingly, ANC technology for blocking noise in open environments is required.

### DISCLOSURE

### Technical Problem

The present invention is directed to providing solutions for all of the above-described problems.

The present invention is also directed to performing a noise process on the basis of noise canceling technology in an open environment and providing a pleasant sleeping environment to a user.

The present invention is also directed to transmitting sound information needed by a user to the user while performing a noise process on the basis of noise canceling technology in an open environment and providing a pleasant sleeping environment to the user.

### Technical Solution

One aspect of the present invention provides a method of blocking noise of a noise canceling pillow including receiving, by a forward microphone, a noise signal, generating, by a noise canceling speaker, a noise canceling signal determined on the basis of the noise signal, receiving, by a feedback microphone, a noise canceled signal generated due to destructive interference between the noise signal and the noise canceling signal, and determining, by a processor, whether to change the noise canceling signal on the basis of the noise canceled signal.

Another aspect of the present invention provides a noise canceling pillow, which blocks noise, including a forward microphone configured to receive a noise signal, a noise canceling speaker configured to generate a noise canceling signal determined on the basis of the noise signal, a feedback microphone configured to receive a noise canceled signal generated due to destructive interference between the noise signal and the noise canceling signal, and a processor configured to determine whether to change the noise canceling signal on the basis of the noise canceled signal.

### Advantageous Effects

According to the present invention, a noise process can be performed on the basis of noise canceling technology in an open environment to provide a pleasant sleeping environment to a user.

Sound information needed by the user can be selectively provided while the noise process is performed on the basis of the noise canceling technology in the open environment.

### DESCRIPTION OF DRAWINGS

FIG. 1 is a conceptual view illustrating a noise canceling pillow according to an embodiment of the present invention.

FIG. 2 is a conceptual view illustrating a noise canceling process of a noise canceling pillow according to an embodiment of the present invention.

FIG. 3 is a conceptual view illustrating a method of generating a noise canceling signal in an open environment according to an embodiment of the present invention.

FIG. 4 is a conceptual view illustrating the method of canceling noise in the open environment according to the embodiment of the present invention.

FIG. 5 is a conceptual view illustrating a method of canceling noise in an open environment according to an embodiment of the present invention.

FIG. 6 is a conceptual view illustrating a differential method of canceling noise according to an embodiment of the present invention.

FIG. 7 is a conceptual view illustrating a noise canceling pillow according to an embodiment of the present invention.

FIG. 8 is a conceptual view illustrating a method of obtaining position information of ears of a user according to an embodiment of the present invention.

### MODES OF THE INVENTION

In the following detailed description of the present inventive concept, references are made to the accompanying drawings that show, by way of illustration, specific embodiments in which the present inventive concept may be practiced. These embodiments are described in sufficient detail to enable those skilled in the art to practice the present inventive concept. It is to be understood that the various embodiments of the present inventive concept, although different from each other, are not necessarily mutually exclusive. For example, specific shapes, structures and characteristics described herein may be implemented as modified from one embodiment to another without departing from the spirit and scope of the present inventive concept. Furthermore, it shall be understood that the locations or arrangements of individual components within each embodiment may also be modified without departing from the spirit and scope of the present inventive concept. Therefore, the following detailed description is not to be taken in a limiting sense, and the scope of the present inventive concept is to be taken as encompassing the scope of the appended claims and all equivalents thereof. In the drawings, like reference numerals refer to the same or similar elements throughout the several views.

Hereinafter, preferred embodiments of the present inventive concept will be described in detail with reference to the accompanying drawings to enable those skilled in the art to easily implement the present inventive concept.

[symbol]

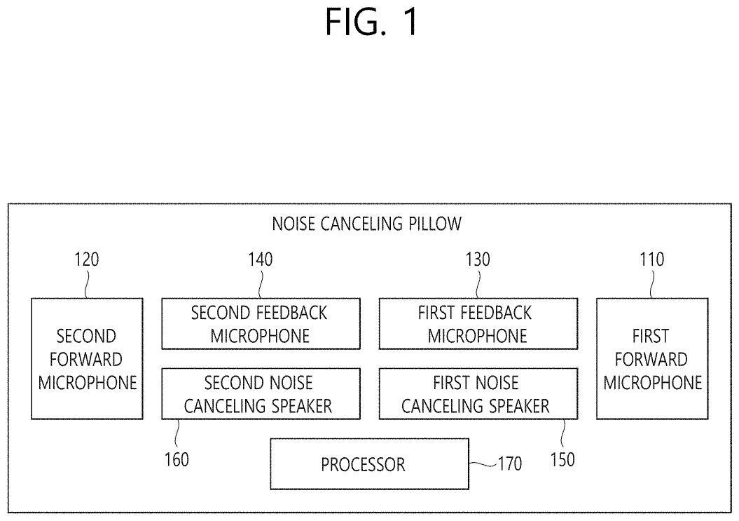

FIG. 1 is a conceptual view illustrating a noise canceling pillow according to an embodiment of the present invention.

In FIG. 1, the noise canceling pillow for blocking ambient noise is disclosed on the basis of an active noise cancelling (ANC) function.

Referring to FIG. 1, the noise canceling pillow may include a plurality of noise canceling speakers. The plurality of noise canceling speakers may each be formed to generate noise canceling signals. The plurality of noise canceling speakers may be positioned at portions adjacent to both ears in a case in which the user lies down using the pillow. Specifically, in a case in which the user lies down to face a ceiling using the noise canceling pillow, a first noise canceling speaker may be positioned at a portion adjacent to a left ear, and a second noise canceling speaker may be positioned at a portion adjacent to a right ear. Hereinafter, the term “noise canceling speaker” will be used for the sake of convenience of description, but the “noise canceling speaker” may also be referred to as a “noise canceling signal generator.”

In addition, the noise canceling pillow may include at least one forward microphone and at least one feedback microphone which have at least one different function from each other.

The noise canceling pillow may include a first forward microphone 110 and a second forward microphone 120. The first forward microphone 110 may be formed to receive a first noise signal input to the left ear of the user, and the second forward microphone 120 may be formed to receive a second noise signal input to the right ear. Only one forward microphone for obtaining information about sound to which the user listens may also be formed in the noise canceling pillow in a case in which noise canceling is not performed. Hereinafter, the term “forward microphone” is used for the sake of convenience of description, but the “forward microphone” may also be referred to as a “sound signal input part.”

In addition, the noise canceling pillow may include a first feedback microphone 130 and a second feedback microphone 140. The first feedback microphone 130 may be formed to feedback information about a first noise canceled signal. The first noise canceled signal may be a first noise signal of which noise is canceled due to a first noise canceling signal generated by a first noise canceling speaker 150. The second feedback microphone 140 may be formed to feedback information about a second noise canceled signal. The second noise canceled signal may be a second noise signal of which noise is canceled due to a second noise canceling signal generated by a second noise canceling speaker 160. Hereinafter, a term “feedback microphone” is used for the sake of convenience of description, but the “feedback microphone” may also be referred to as a “noise canceled signal input part.”

In addition, the noise canceling pillow may include a processor 160. The processor 160 may determine characteristics of noise signals input through the forward microphones and characteristics of noise canceling signals for performing noise canceling on the noise signals. In addition, the processor 160 may be formed such that the noise canceling speakers generate the noise canceling signals having the determined characteristics. In addition, the processor may be formed to receive noise canceled signals input through the feedback microphones so as to change the characteristics of the noise canceling signals.

Hereinafter, in the embodiment of the present invention, two noise canceling speakers (the first noise canceling speaker 150 and the second noise canceling speaker 160), two forward microphones (the first forward microphone 110 and the second forward microphone 120), and two feedback microphones (the first feedback microphone 130 and the second feedback microphone 140) are disclosed. However, the number of the noise canceling speakers, the number of the forward microphones, and the number of the feedback microphones are only examples. The number of noise canceling speakers, the number of forward microphones, and the feedback microphones may be changed.

[symbol]

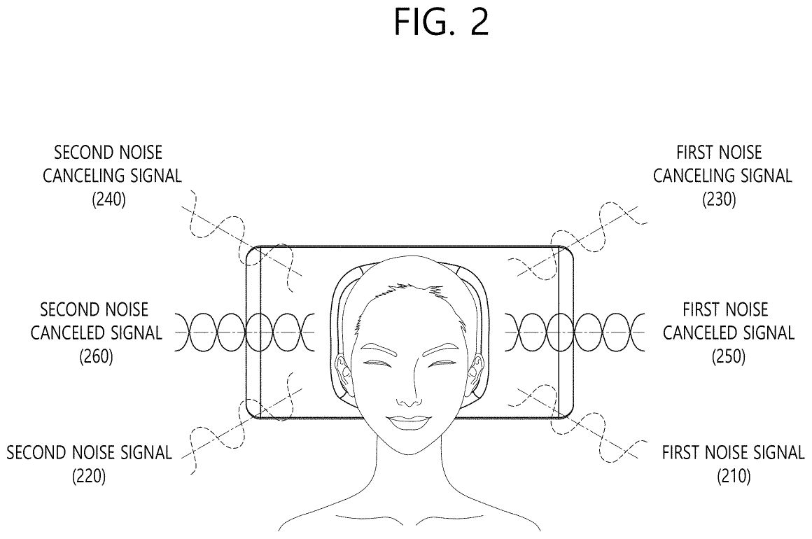

FIG. 2 is a conceptual view illustrating a noise canceling process of a noise canceling pillow according to an embodiment of the present invention.

In FIG. 2, the noise canceling process of a noise canceling pillow is disclosed.

Referring to FIG. 2, forward microphones formed in the noise canceling pillow receive noise signals.

As described above, a first forward microphone may be disposed at a position adjacent to a first noise canceling speaker and receive a first noise signal 210 input to a left ear of a user. A second forward microphone may be disposed at a position adjacent to a second noise canceling speaker and receive a second noise signal 220 input to the right ear of the user.

The noise signals received through the forward microphones are transmitted to a processor.

The processor may receive the noise signals and determine characteristics of noise canceling signals to cancel the noise signals. The noise canceling signals may include a first noise canceling signal 230 to cancel the first noise signal 210 and a second noise canceling signal 240 to cancel the second noise signal.

The first noise canceling signal 230 may be generated to have a phase opposite to a phase of the first noise signal 210. The first noise canceling signal 230 may cancel the first noise signal 210 to generate a first noise canceled signal 250. The second noise canceling signal 240 may be formed to have a waveform opposite to a waveform of the second noise signal 220. The second noise canceling signal 240 may cancel the second noise signal 220 to generate a second noise canceled signal 260.

The feedback microphones may receive information about the noise canceled signals and transmit the information about the noise canceled signals to the processor.

A first feedback microphone may receive the information about the first noise canceled signal 250, and a second feedback microphone may receive the information about the second noise canceled signal 260. The first feedback microphone may transmit the first noise canceled signal 250 to the processor, and the second feedback microphone may transmit the second noise canceled signal 260 to the processor.

The processor may determine whether to change characteristics of the first noise canceling signal 230 and characteristics of the second noise canceling signal 240 on the basis of the first noise canceled signal 250 and the second noise canceled signal 260.

For example, in a case in which a size of the first noise canceled signal 250 is less than or equal to a threshold size, the characteristics of the first noise canceling signal 230 for canceling the first noise signal 210 may be maintained without being changed. However, in a case in which the size of the first noise canceled signal 250 is greater than the threshold size, the characteristics of the first noise canceling signal 230 for canceling the first noise signal 210 may be changed.

That is, in the case in which the size of the noise canceled signal is less than or equal to the threshold size, the processor may determine that there is a noise signal canceling effect and maintain the characteristics of the noise canceled signal. However, in the case in which the size of the noise canceled signal is greater than the threshold size, the processor may determine that a noise signal canceling effect of a present noise canceling signal used for canceling a noise signal is not high and change the characteristics of the noise canceled signal. The processor may newly determine a phase and a size of an amplitude of the noise canceling signal on the basis of a result of a feedback and change the characteristics of the noise canceling signal.

That is, the processor may determine whether to change characteristics of the first noise canceling signal 230 and the characteristics of the second noise canceling signal 240 on the basis of the first noise canceled signal 250 and the second noise canceled signal 260.

[symbol]

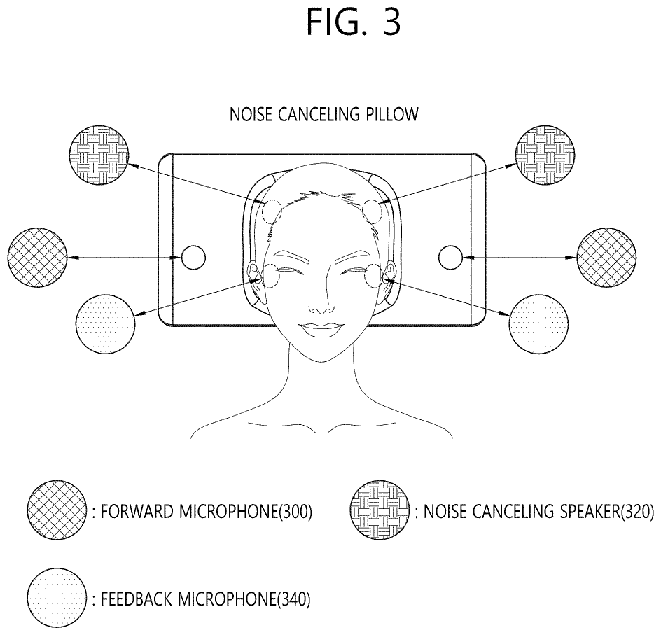

FIG. 3 is a conceptual view illustrating a method of generating a noise canceling signal in an open environment according to an embodiment of the present invention.

In FIG. 3, a method of performing noise canceling in an open environment, which is not a closed environment like conventional headphones, is disclosed.

Referring to FIG. 3, destructive interference should be performed between noise canceling signals, which are generated by a plurality of noise canceling speakers which generate the noise canceling signals, and noise signals in the open environment.

In the closed environment like the conventional headphones, positions of forward microphones 300, positions of feedback microphones 340, and positions of noise canceling speakers 320 may be positioned adjacent to each other. Specifically, the forward microphones 300 may measure noise at positions adjacent to ears of a user, and the noise canceling speakers 320 may generate noise canceling signals for canceling the noise at positions adjacent to the ears. The feedback microphones 340 may measure noise canceled signals at positions very close to the ears.

That is, in the closed environment, characteristics of noise introduced into the forward microphones 300 may be identical/similar to characteristics of noise introduced into the ears of the user, and destructive interference may be performed between the noise canceling signals generated by the noise canceling speakers 320 and noise signals.

However, the noise canceling pillow may perform a noise canceling process in the open environment. Actually, the positions of the forward microphones 300 which receive noise signals, the positions of the noise canceling speakers 320 which generate noise canceling signals for performing noise canceling on the noise signals, and the positions of the feedback microphones 340 which receive noise canceled signals on which the noise canceling is performed may be positioned relatively far away from each other in the open environment. In addition, in a case in which the positions of the forward microphones 300 are not adjacent to positions of the ears of the user, the noise signals input to the forward microphones 300 may have different characteristics (for example, phases) from the noise signals input to the ears of the user. In addition, in a case in which the positions of the noise canceling speakers 320 are not adjacent to the positions of the ears of the user, destructive interference may not be precisely performed between the noise canceling signals generated by the noise canceling speakers 320 and the noise signals input to the ears of the user due to a phase difference.

Accordingly, in the open environment, prediction for noise signals input to the ears of the user may be performed on the basis of the positions of the ears of the user so as to determine predicted noise signals. In addition, noise canceling signals for the determined predicted noise signals may also be determined. In addition, in a case in which distances from the feedback microphones 340 to the ears of the user are greater than or equal to a threshold distance, the processor may also determine whether destructive interference is actually performed between the noise signals and the noise canceling signals in the ears of the user on the basis of noise canceled signals received from the feedback microphones 340 and may change characteristics of the noise canceling signals.

Hereinafter, a method of canceling noise in an open environment will be disclosed according to an embodiment of the present invention.

[symbol]

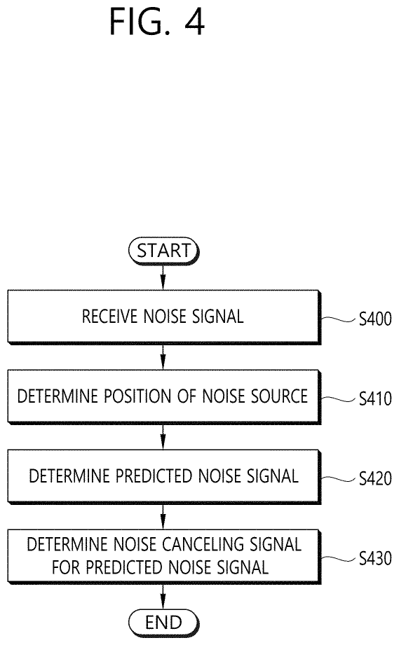

FIG. 4 is a conceptual view illustrating the method of canceling noise in the open environment according to the embodiment of the present invention.

In FIG. 4, a method of determining predicted noise signals for noise canceling in the open environment is disclosed. The predicted noise signals may be determined by predicting noise signals input to ears of a user on the basis of noise signals input to forward microphones.

Referring to FIG. 4, the predicted noise signals may be determined on the basis of information about the noise signals input to the forward microphones and information about positions of the forward microphones and the ears of the user.

Specifically, a processor may receive noise signals (S400).

A first forward microphone may be positioned at a position adjacent to a first noise canceling speaker and may receive a first noise signal input to a left ear of a user. A second forward microphone may be positioned at a position adjacent to a second noise canceling speaker and may receive a second noise signal input to the right ear of the user.

The processor may determine a position of a noise source on the basis of information about the first noise signal and the second noise signal (S410).

For example, in a case in which a snoring user is positioned at the left of the user, the position of the noise source may be determined to be the left of the user on the basis of the information about the first noise signal and the second noise signal.

The processor determines predicted noise signals (S420).

In the case in which the position of the noise source is determined, differences in position between the forward microphones and the ears of the user may be determined. In a case in which the positions of the ears of the user are fixed, the differences in position between the forward microphones and the ears of the user may have fixed values. In a case in which the positions of the ears of the user are not fixed, the differences in position between the forward microphones and the ears of the user may have variable values. The positions of the ears of the user may be determined through various methods. The methods will be specifically described below.

Characteristics of a first predicted noise signal input to the left ear of the user may be determined on the basis of a position of the noise source, a position of the left ear of the user, a position of the first forward microphone, and a first noise signal (and/or a second noise signal). Characteristics of an amplitude and/or a phase of the first noise signal may be different from characteristics of an amplitude and/or a phase of the first predicted noise signal. For example, a case may be assumed in which the first forward microphone is closer to the noise source than the left ear. In this case, the amplitude of the first noise signal may be greater than the amplitude of the first predicted noise signal. In addition, the first predicted noise signal may have a phase having a value in which a phase of the first noise signal is shifted in a predetermined direction by considering the position of the first forward microphone and a distance to the left ear.

Similarly, characteristics of a second predicted noise signal input to the right ear of the user may be determined on the basis of the position of the noise source, a position of the right ear of the user, a position of the second forward microphone, and the second noise signal (and/or the first noise signal). Characteristics of an amplitude and/or a phase of the second noise signal may be different from characteristics of an amplitude and/or a phase of the second predicted noise signal. For example, a case may be assumed in which the second forward microphone is further away from the noise source. In this case, the amplitude of the second noise signal may be relatively less than the amplitude of the second predicted noise signal. In addition, the phase of the second predicted noise signal may have a value in which the phase of the second noise signal is shifted in a predetermined direction by considering the position of the second forward microphone and a distance to the right ear.

The processor may determine the characteristics of the noise canceling signals such that the noise canceling signals generated by the noise canceling speakers cancel the predicted noise signals.

That is, the forward microphones may receive the noise signals, and the noise canceling speakers may generate the noise canceling signals determined on the basis of the noise signals such that the noise canceling pillow blocks noise. In addition, the feedback microphones may receive noise canceled signals generated by performing destructive interference between the noise signals and the noise canceling signals. The processor may determine whether to change the noise canceling signals on the basis of the noise canceled signals.

The forward microphones, the noise canceling speakers, and the feedback speakers may operate in the open environment, and the forward microphones, the noise canceling speakers, and the feedback speakers may be spaced apart from each other by distances greater than or equal to a threshold distance.

Due to such characteristics in the open environment, characteristics (for example, phases and amplitudes) of the noise signals received by the forward microphones may be different from characteristics of the noise signals input to the ears of the user, and characteristics of the noise canceled signals received by the feedback microphones may be different form characteristics of the noise canceled signals input to the ears of the user.

The processor may predict the characteristics of the noise signals input to the ears of the user on the basis of the characteristics (for example, the phases) of the noise signals received by the forward microphones to determine the predicted noise signals. The noise canceling signals may be determined to perform destructive interference with the predicted noise signals. In addition, the processor may predict the characteristics of the noise canceled signals, which are input to the ears of the user on the basis of the noise canceled signals received by the feedback microphones. The processor may determine whether to change the noise canceling signals on the basis of the characteristics of the noise canceled signals input to the ears of the user.

[symbol]

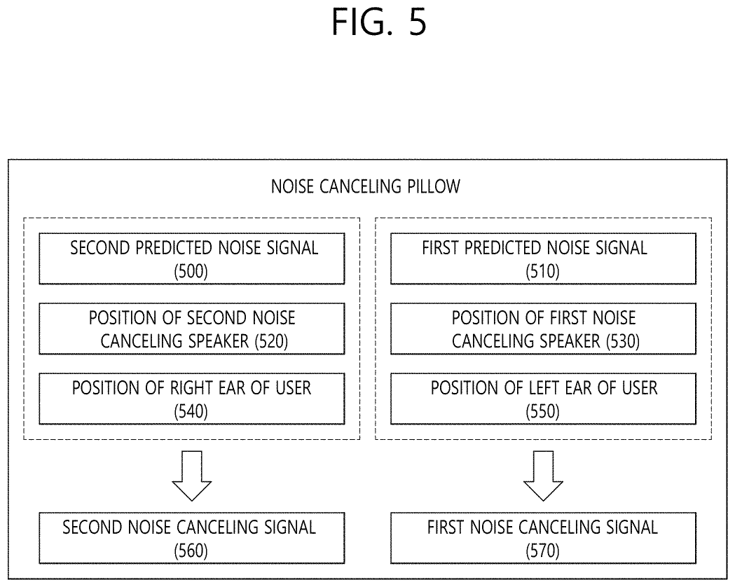

FIG. 5 is a conceptual view illustrating a method of canceling noise in an open environment according to an embodiment of the present invention.

In FIG. 5, a method of generating noise canceling signals against predicted noise signals is disclosed.

Referring to FIG. 5, destructive interference should be performed between noise canceling signals generated by noise canceling speakers positioned adjacent to ears of a user and predicted noise signals. Accordingly, a processor may determine characteristics of the noise canceling signals to cancel the predicted noise signals at positions adjacent to the ears of the user by considering characteristics of the predicted noise signals.

The processor may determine the characteristics of the noise canceling signals such that the noise canceling signals generated by the noise canceling speakers cancel the predicted noise signals at the positions adjacent to the ears of the user. For example, the characteristics of the noise canceling signals may be determined such that phase differences between the noise canceling signals generated by the noise canceling speakers and the predicted noise signals are 180° at positions adjacent to the ears of the user.

Specifically, the processor may determine a phase and an amplitude of a first noise canceling signal 570 such that a first predicted noise signal 510 is canceled at a position adjacent to the left ear of the user due to signal characteristics of the first noise canceling signal 570 generated by a first noise canceling speaker by considering a position 530 of the first noise canceling speaker and a position 550 of the left ear of the user.

Similarly, the processor may determine a phase and an amplitude of a second noise canceling signal 560 such that a second predicted noise signal 500 is canceled at a position adjacent to the right ear of the user due to signal characteristics of the second noise canceling signal 560 generated by a second noise canceling speaker by considering a position 520 of the second noise canceling speaker and a position 540 of the right ear of the user.

[symbol]

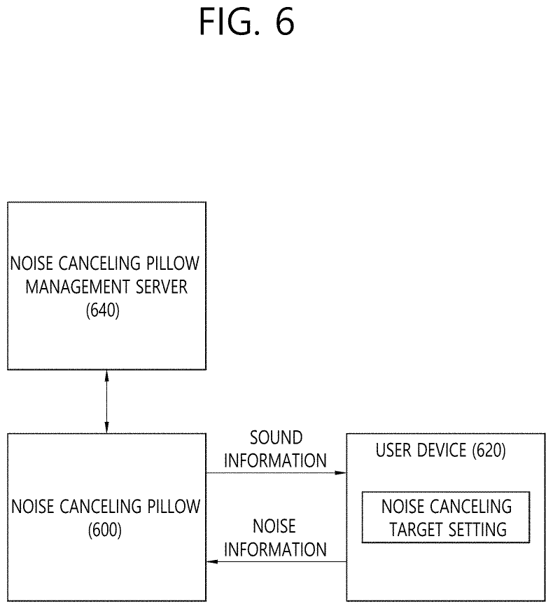

FIG. 6 is a conceptual view illustrating a differential method of canceling noise according to an embodiment of the present invention.

In FIG. 6, a method of canceling noise to selectively transmit sound information needed by a user is disclosed.

Referring to FIG. 6, a sound, such as a snore which disturbs deep sleep, in sound information input to ears of the user needs to be blocked because the sound is noisy. However, in a case in which a baby crying sound or a set alarm sound is blocked as a noise signal, the noise canceling pillow 600 may cause inconvenience in a daily life of a parent raising a baby.

Accordingly, a method of blocking only a sound unnecessary to the user will be described.

According to the present embodiment, a method may be used in which a noise signal in a frequency band less than or equal to a threshold value is removed using a noise canceling method and a noise signal in a frequency band (relatively high frequency band) greater than the threshold value is filtered using a sound insulation material/sound absorption material or the like.

Alternatively, a noise canceling pillow 600 may be formed to block an unnecessary noise signal to the user according to a user's setting. For example, information about noise that the user does not want to hear among noise signals may be selected by the noise canceling pillow 600 by itself or by operating in conjunction with another user device (for example, a smartphone) 620. Noise canceling may be selectively performed on selected noise.

Noise signals input to the noise canceling pillow 600 may be collected for a predetermined time period so as to initially set the noise canceling pillow 600, and the user may check the collected noise signals. For example, the noise canceling pillow 600 may transmit information about collected sound signals to the user device 620. The user device 620 may provide information about collected noise signals to the user. Specifically, the noise signals may be classified by the user device 620, and the classified noise signals may be provided to the user using various types such as text, icon, and graphic types. The user may select specific sounds among the classified noise signals and set the specific sounds as noise signals that the user does not want to hear while sleeping. The user device 620 may transmit information about the noise signals set by the user to the noise canceling pillow 600. In a case in which the set noise signals occur, the noise canceling pillow 600 may generate noise canceling signals for the set noise signals.

In the above embodiment, an example case has been described in which the noise canceling pillow 600 selectively sets noise by operating in conjunction with the user device 620. The noise canceling pillow 600 may also set noise signals and selectively cancel only the noise signals without operating in conjunction with the user device 620.

In addition, according to the embodiment of the present invention, the noise canceling pillow 600 may also determine whether a corresponding sound is similar to noise set by the user and automatically cancel the noise by considering characteristics of the sound. For example, in a case in which a snore is set as noise by the user, a sound having characteristics (frequency, amplitude, and generating pattern) similar to those of the snore set as the noise may be determined as the noise and canceled.

In addition, the noise canceling pillow 600 may be connected to a noise canceling pillow management server 640, and the noise canceling pillow 600 may transmit information about received noise signals/noise signals set to be canceled to the noise canceling pillow management server 640. The noise canceling pillow management server 640 may classify and determine information that the user feels as noise on the basis of information about noise signals received from a plurality of noise canceling pillows/noise signals set to be canceled. For example, the noise canceling pillow management server 640 may classify information about various snores among collected sounds and determine noise canceling signals for performing noise canceling on the various snores. Information about the determined noise canceling signals may be transmitted to the noise canceling pillow 600. The noise canceling pillow 600 may generate noise canceling signals on the basis of the information about the received noise canceling signals.

[symbol]

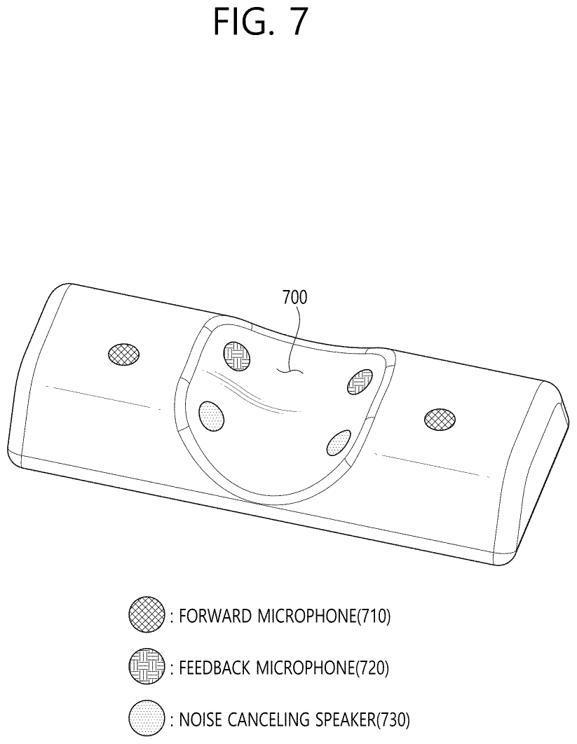

FIG. 7 is a conceptual view illustrating a noise canceling pillow according to an embodiment of the present invention.

In FIG. 7, a shape and a structure of the noise canceling pillow are disclosed.

Referring to FIG. 7, a groove 700 in which a face of a user is positioned may be formed at a central portion of the noise canceling pillow. The groove 700 may be formed such that the user's face does not move greatly on the pillow so as to improve noise canceling effect. For example, the user's face may be positioned in the groove 700 to face a ceiling.

Forward microphones 710, noise canceling speakers 730, and feedback microphones 720 may be positioned at various positions on the noise canceling pillow. For example, the forward microphones 710, the noise canceling speakers 730, and the feedback microphone 720 may be positioned adjacent to each other around ears of the user. However, the forward microphones 710, the noise canceling speakers 730, and the feedback microphones 720 may also not be positioned adjacent to each other around the ears of the user, and the forward microphones 710, the noise canceling speakers 730, and the feedback microphone 720 may be positioned to be spaced apart from each other. In a case in which the forward microphones 710, the noise canceling speakers 730, and the feedback microphone 720 are spaced distances from each other, the noise canceling pillow according to the embodiment of the present invention may determine predicted noise signals by considering positions of the forward microphones 710, the noise canceling speakers 730, and the feedback microphones 720 and generate noise canceling signals according to the predicted noise signals.

For example, a first forward microphone may be positioned at a left protrusion from the user's face positioned in the groove, and a second forward microphone may be positioned at a right protrusion from the groove 700. A first feedback microphone and a first noise canceling speaker may be positioned at inclined portions between the left protrusion close to the left ear of the user and the groove 700. A second feedback microphone and a second noise canceling speaker may be positioned at inclined portions between the right protrusion close to the right ear of the user and the groove 700.

In the case in which the groove 700 is formed in the noise canceling pillow, the user's face may be fixed, and positions of the ears of the user may be fixed. In this case, since the positions of the ears of the user are fixed, predicted noise signals may be determined even without considering movement of the user. However, in a case in which the groove 700 is not formed in the noise canceling pillow or the user's face moves continuously while the user is sleeping, since positions of the ears of the user are not fixed, it is needed to determine predicted noise signals and generate noise canceling signals by considering movement of the user (positions of the ears of the user).

[symbol]

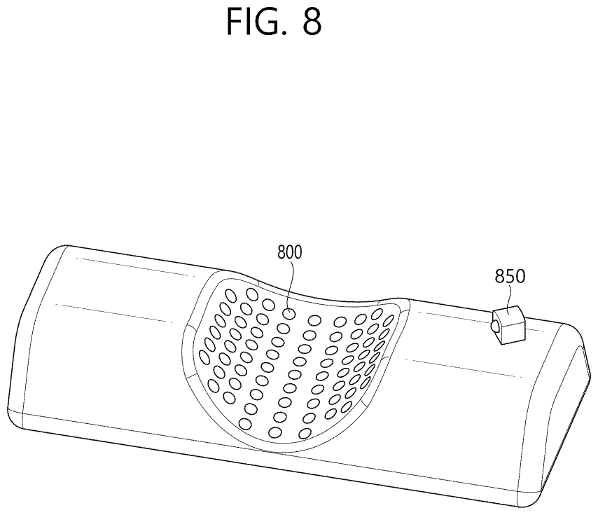

FIG. 8 is a conceptual view illustrating a method of obtaining position information of ears of a user according to an embodiment of the present invention.

In FIG. 8, a method of determining predicted noise signals and generating noise canceling signals by sensing positions of the ears of the user is disclosed.

Referring to FIG. 8, a position of a face (or positions of the ears) of the user may be continuously changed while the user is sleeping, and predicted noise signals may be determined and noise canceling signals may be generated by determining a change of a position of the user's face (or positions of the ears).

Various methods may be used to determine the positions of the ears of the user. For example, a plurality of weight sensors 800 configured to sense weights may be formed at a plurality of positions in a noise canceling pillow. A sleeping state of the user may be determined on the basis of sensing results of the plurality of weight sensors 800. For example, in a case in which the user is sleeping while facing a ceiling, a portion corresponding to a back of a user's head is in close contact with the pillow, and the weight sensors 800 of the noise canceling pillow may detect weights in an area corresponding to the back of the user's head. Sensing values sensed in the area corresponding to the back of the user's head by the plurality of weight sensors may be different from each other. The noise canceling pillow may determine that the user is sleeping while facing the ceiling on the basis of the sensing results of the weight sensor 800.

In a case in which the user is sleeping while turned to a side so that the user faces in a left or right direction, a portion corresponding to the left face or right face of the user may be in close contact with the pillow. The weight sensors 800 of the noise canceling pillow may detect different weights in areas corresponding to the left face and the right face of the user. The noise canceling pillow may determine that the user is sleeping to face in the left or right direction on the basis of the sensing results of the weight sensors 800.

That is, while the user is sleeping, a form of the user may be estimated on the basis of the sensing results of the plurality of weight sensors 800 formed in the noise canceling pillow, and positions of the ears of the user may be estimated. Predicted noise signals may be determined by considering the estimated positions of the ears, and noise canceling signals may also be generated by considering the predicted noise signals.

As another method, a separate image capturing part 850 may be formed in a noise canceling pillow, and a position of a current user may be determined. For example, the image capturing part 850 may be formed on one surface of the noise canceling pillow, and the image capturing part 850 may capture an image of a face of the user. Information about the captured image of the user's face may be transmitted to a processor. The processor may estimate positions of ears of the user on the basis of the information about the user's face, determine predicted noise signals by considering the positions of the ears of the user, and determine noise canceling signals for the predicted noise signals.

[symbol]

The above-described embodiments of the present invention may be implemented in the form of program instructions executable by various computer elements and recorded in a computer-readable recording medium. The computer-readable recording medium may include program instructions, data files, data structures, etc. alone or in combination. The program instructions recorded on the computer-readable recording medium may be specially designed and configured for the present invention or known to and used by those of ordinary skill in the computer software field. Examples of the computer-readable recording medium include magnetic media, such as a hard disk, a floppy disk, and magnetic tape, optical media, such as a compact disc read-only memory (CD-ROM) and a digital versatile disc (DVD), magneto-optical media, such as a floptical disk, and hardware devices, such as a ROM, a random access memory (RAM), and a flash memory, specially configured to store and perform program instructions. Examples of the program instructions include not only machine language code produced by a compiler but also high-level language code that can be executed by a computer through an interpreter or the like. To perform the operations of the present invention, the hardware devices may be configured as one or more software modules, and vice versa.

While the present invention has been described above with reference to specific details, such as detailed elements, by way of limited embodiments and drawings, these are provided merely to aid the overall understanding of the present invention. The present invention is not limited to the embodiments, and various modifications and changes can be made thereto by those of ordinary skill in the technical field to which the present invention pertains.

Therefore, the spirit of the present invention should not be limited to the above-described embodiments, and the scope of the present invention should be regarded as encompassing not only the following claims but also their equivalents and variations.

1-11. (canceled)

12. A method of blocking noise of a noise canceling pillow, comprising:
receiving, by a forward microphone, a noise signal;
generating, by a noise canceling speaker, a noise canceling signal determined on the basis of the noise signal;
receiving, by a feedback microphone, a noise canceled signal generated due to destructive interference between the noise signal and the noise canceling signal; and
determining, by a processor, whether to change the noise canceling signal on the basis of the noise canceled signal.

13. The method of claim 12, wherein the forward microphone, the noise canceling speaker, and the feedback speaker operate in an open environment; and
the forward microphone, the noise canceling speaker, and the feedback speaker are positioned to be spaced apart from each other by a distance greater than or equal to a threshold distance.

14. The method of claim 13, wherein a phase of the noise signal received by the forward microphone is different from a phase of the noise signal input to an ear of a user; and
a phase of the noise canceled signal received by the feedback microphone is different from a phase of the noise canceled signal input to the ear of the user.

15. The method of claim 14, wherein the processor predicts the phase of the noise signal input to the ear of the user on the basis of the phase of the noise signal received by the forward microphone and determines a predicted noise signal; and
the noise canceling signal is determined to perform destructive interference with the predicted noise signal.

16. The method of claim 15, wherein the processor predicts a characteristic of the noise canceled signal input to the ear of the user on the basis of the noise canceled signal received by the feedback microphone; and
determines whether to change the noise canceling signal on the basis of the characteristic of the noise canceled signal input to the ear of the user.

17. A noise canceling pillow which blocks noise, comprising:
a forward microphone configured to receive a noise signal;
a noise canceling speaker configured to generate a noise canceling signal determined on the basis of the noise signal;
a feedback microphone configured to receive a noise canceled signal generated due to destructive interference between the noise signal and the noise canceling signal; and
a processor configured to determine whether to change the noise canceling signal on the basis of the noise canceled signal.

18. The noise canceling pillow of claim 17, wherein the forward microphone, the noise canceling speaker, and the feedback speaker operate in an open environment; and
the forward microphone, the noise canceling speaker, and the feedback speaker are positioned to be spaced apart from each other by a distance greater than or equal to a threshold distance.

19. The noise canceling pillow of claim 18, wherein a phase of the noise signal received by the forward microphone is different from a phase of the noise signal input to an ear of a user; and
a phase of the noise canceled signal received by the feedback microphone is different from a phase of the noise canceled signal input to the ear of the user.

20. The noise canceling pillow of claim 19, wherein the processor predicts the phase of the noise signal input to the ear of the user on the basis of the phase of the noise signal received by the forward microphone and determines a predicted noise signal; and
the noise canceling signal is determined to perform destructive interference with the predicted noise signal.

21. The noise canceling pillow of claim 20, wherein the processor predicts a characteristic of the noise canceled signal input to the ear of the user on the basis of the noise canceled signal received by the feedback microphone; and
determines whether to change the noise canceling signal on the basis of the characteristic of the noise canceled signal input to the ear of the user.
